(19) United States
(12) Patent Application Publication
(10) Pub. No.: US 2011/0302660 A1
(43) Pub. Date: Dec. 8, 2011

(54) METHOD AND APPARATUS FOR SECURING DIGITAL DEVICES WITH LOCKING CLOCK MECHANISM

(76) Inventor: Rupaka Mahalingaiah, Austin, TX (US)

(21) Appl. No.: 12/792,705

(22) Filed: Jun. 2, 2010

(51) Int. Cl. G06F 21/00; G06F 1/26

(52) U.S. Cl. 726/28; 713/300

(57) ABSTRACT

A mechanism to secure a synchronous digital device such as a Mobile Device is provided. Using the clocking mechanisms of the synchronous digital designs, the invention enables mechanisms to secure Mobile devices. When a potential security breach is detected, blocking the clock will disable the Mobile Device. The invention also contemplates mechanisms to re-enable the Mobile Device when the security risk from the block condition is resolved. The invention further contemplates mechanisms to secure the enterprise information technology system from the hacked or stolen Mobile Devices.

### BACKGROUND OF THE INVENTION

1. Field of the Invention

This invention relates to digital systems (such as mobile devices, microprocessors, memory devices, and computer systems) and, more particularly, to mechanisms and techniques to secure the devices using the controlled clocking mechanism of the digital designs.

2. Brief Description of the Related Technology

Electronic digital computational devices like computers, laptops, netbooks, PDAs, memories, handheld, smart phones, and mobile digital devices (collectively called ‘Mobile Devices’) have become the critical part of many businesses. These devices provide significant computing and previously unavailable data communication capabilities. Availability and affordability of these devices is also expanding with their accompanying proliferation.

This popular trend has resulted in the increased need for securing the Mobile Devices. In a business atmosphere, these Mobile Devices frequently contain secure information that relates to the businesses. The Mobile Devices typically have the ability to connect to the servers and enterprise information technology infrastructure (collectively called ‘Enterprise Server’) to communicate and access information on the server. They also store and retain confidential information on their local hard drive or other such storage units.

These Mobile Devices are inherently prone to being misplaced, dropped, lost, or stolen. Potential compromise of data retained internally is very high. Additionally, perpetrators can access the Enterprise Server by using these lost devices. It is possible to compromise the entire IT infrastructure of a business by the lost Mobile Devices.

There is a critical need for comprehensive security solutions that secure both transmitted and stored information. Development of a suitable security solution will demand creativity and innovation as the resultant approach must be viable and at the same time it must not add significantly to the Mobile Devices' computational load or otherwise degrade device functionality and responsiveness.

Personal Mobile Devices, while incorporating increasingly powerful computers, simultaneously are fitted with software applications, integrated hardware subsystems, etc which must be serviced by the Enterprise Server. This also necessitates an innovative approach to Mobile Device security and also communication device.

There are many security mechanisms for securing the Mobile Devices. The first and foremost is protecting the devices with passwords. This simple technique can protect both the Enterprise Server and the Mobile Device from casual intrusions. However, this will not be able to offer protection from serious hackers.

There are several data encryption techniques and these are used in some high-end laptop and desktop computers. However, these are not always best suited for use in Mobile Devices. The solid-state mass storage system in a Mobile Device may not be compatible with those techniques or the computational workload may be excessive. Similarly, simple addition of available wireless network encryption hardware is undesirable as battery run-time is yet another issue that is critical in some Mobile Devices. Added hardware will shorten device runtime and increase frequency of recharge.

Thus, in addition to an innovative approach to securing the Mobile Devices, the mechanism should avoid adverse impact to the device's intended purpose and minimal additional hardware, if any, to avoid noticeable reduction in battery life as well as increase in physical size of the device.

Industry has also introduced unique techniques like Remote Wiping to protect Mobile Devices. This typically involves the Enterprise Server wiping out the Mobile Device clean when potential hackers activate the lost Mobile Device. This technique is effective in protecting the Enterprise Server from many potential perpetrators. However, there are several vulnerabilities with this technique. The information on the Mobile Device can be stolen without activating the device. A technically savvy hacker may be able to access the Enterprise Server without activating Mobile Device by using the information contained in the Mobile Device.

The vulnerabilities in techniques available today can be exploited by professional hackers compromising the Enterprise Server. While the mechanisms of today offer security that is sufficient for most users, they are inadequate for security critical applications.

Some Mobile Devices have hardware keys such as an USB device or a RF key to protect them from potential hackers. These can be cumbersome to the normal user and also present the opportunity of being stolen or lost along with the Mobile Device.

A more secure mechanism is desirable for security critical applications. To provide a high level of security, using robust algorithms and encryption algorithms in software will be power and resource prohibitive in Mobile Device. Alternative to software techniques is the hardware techniques that can provide robust higher level of security. However, using special hardware techniques by adding hardware into Mobile Devices are not acceptable due to power and resource constraints.

It will be advantageous to have simple hardware techniques that will enable robust security yet not compound resource and power issues of Mobile Devices. Towards keeping the resource requirement to a minimum, it will be advantageous for any new mechanism to make use of existing resources in the Mobile Devices.

### SUMMARY OF THE INVENTION

The problems outlined above are in large part solved by a design in accordance with the various embodiments of this invention. Embodiments of this invention are adaptable for use in any Mobile Device, computer systems, or other digital designs.

In particular, the invention contemplates on using the clock scheme of a synchronous digital design to provide a lock-up mechanism. This lock-up mechanism will enable a simple, yet robust foolproof mechanism to protect not only the Mobile Devices but also, more critically, the Enterprise Servers from hackers and intruders.

Most digital designs of today, including microprocessors, computer systems, memory subsystems, and Mobile Devices are based on synchronous design methodology. The term “synchronous design” generally refers to the method employed to control the timing of the design. A clock (a signal with deterministic period of state change) generally controls the time at which the events are executed within a synchronous digital design in a deterministic fashion. All timed elements in synchronous digital designs use clocking mechanism for their operation. One or more clocks control the operation of all clocked units in the system. In addition to driving the operation of each unit in a system, clocks also guarantee the time synchronization of various units within the design. Most digital designs of today use this methodology and there is a wealth of Computer Aided Design (CAD) tools and verification tools and methodology to support this.

A digital design typically has a centralized clock system with a well-balanced clock tree controlling, coordinating, and synchronizing the entire design. Typically, free-running clock tree can account for 30-40% of the power in high performance designs of today. To reduce this power consumption, many clock management schemes are available. This often involves of implementing mechanisms to disable clocks by generating signals that enable or disable clocks. These signals are gated with respective clocks to control the enabling or disabling of the clock.

Mobile Devices are especially sensitive to power consumption. Extending the life of battery and/or lowering the power consumption are crucial for Mobile Devices. Mobile Devices implement power management techniques to reduce power consumption. Controlling the clocks is an important part of the power reduction techniques deployed in Mobile Devices.

This invention provides various embodiments of mechanisms to utilize the clock and/or power management scheme of Mobile Devices to enable security from potential hackers. The problem of potential security breach by compromised Mobile Device is in large part solved in embodiments of this invention by using the clock and/or power management scheme to disable the clock when unauthorized access is detected.

Embodiments of this invention contemplate on mechanisms to detect potential security breach. Various embodiments of the invention further contemplate mechanisms to disable clocks to one or more units in the Mobile Device. Several embodiments of the invention further contemplate mechanisms to protect the Enterprise Server in addition to the Mobile Device. Various embodiments of invention further contemplate mechanisms to re-enable the Mobile Devices if and when the security risk is resolved.

Embodiments of the invention provide a Mobile Device with ability to stop normal operations by stopping or locking the clocks to one or more parts of the device when a potential security breach is detected.

In one embodiment, the invention provides a Mobile Device comprising of an application processor, a power management unit, a display, a network interface, a memory system, a keyboard and touchscreen, a USB port, audio devices, camera, and a clock unit mechanism to stop normal operations when a potential security breach is detected.

In another embodiment, the invention provides Mobile Device with a mechanism to stop the clock supplied to one or more of the units of the Mobile Device.

In another embodiment, the invention provides Mobile Device with a mechanism to stop the clock by detecting the potential breach from the CPU of the application processor.

In yet another embodiment, the invention provides Mobile Device with a mechanism to generate an interrupt when potential security breach is detected.

In yet another embodiment, the invention provides mechanism to disable the communication capability of the Mobile Device when a potential security breach is detected.

In one embodiment, the invention provides a method to protect the integrity of the Enterprise Server by disabling the Mobile Device that has detected potential security breach.

In another embodiment, the invention provides for a mechanism to control the tolerance level of detecting potential security breach.

While this preferred embodiments of the invention are primarily beneficial in personal mobile devices, other embodiments of the invention further contemplates using the mechanism for desktop and other computing devices with communication capabilities. Embodiments of this invention will secure the Enterprise Server that has one or more devices that connect to it remotely. Other embodiments of the invention can be used in any remote connectivity applications to prevent security breach.

A further understanding of the nature and advantages of the present invention may be realized by reference to the remaining portions of the specification and the drawings.

### BRIEF DESCRIPTION OF THE DRAWINGS

So that the manner in which the above recited advantages and features of the present invention, as well as others which will become apparent, are attained and can be understood in detail, a more particular description of the invention summarized above may be had by reference to the embodiment thereof which is illustrated in the appended drawings, which drawings form a part of this specification.

It is to be noted, that the appended drawings only illustrate the typical embodiments of the invention and therefore should not to be considered limiting of its scope, for the invention may admit to other equally effective embodiments.

FIG. 1 is a block diagram of one embodiment of a typical Mobile Device configured in accordance with the present invention.

FIG. 2a is a block diagram of one embodiment of implementing clock locking mechanism of this invention when power management controls the clocking mechanism.

FIG. 2b is a block diagram of one embodiment of implementing clock locking mechanism of this invention when power management does not control the clocking mechanism.

FIG. 3 is a block diagram of one embodiment of a typical processing unit configured in accordance with the present invention.

FIG. 4 is flow chart summarizing a method for triggering lock clock mechanism.

FIG. 5 is a block diagram of one embodiment of a Mobile Device configured with clock lock interrupt in accordance with the present invention.

FIG. 6 is a block diagram of one embodiment of a network interface unit configured with clock lock interrupt in accordance with the present invention.

FIG. 7 is a flow chart depicting method for reactivating a Mobile Device after the security risk is resolved.

FIG. 8 is a flow chart showing a method for preserving the integrity of an Enterprise Server from hackers.

### DETAILED DESCRIPTION OF THE PREFERRED EMBODIMENTS

While the invention is susceptible to various modifications and alternative forms, specific embodiments thereof are shown by way of example in the drawing and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

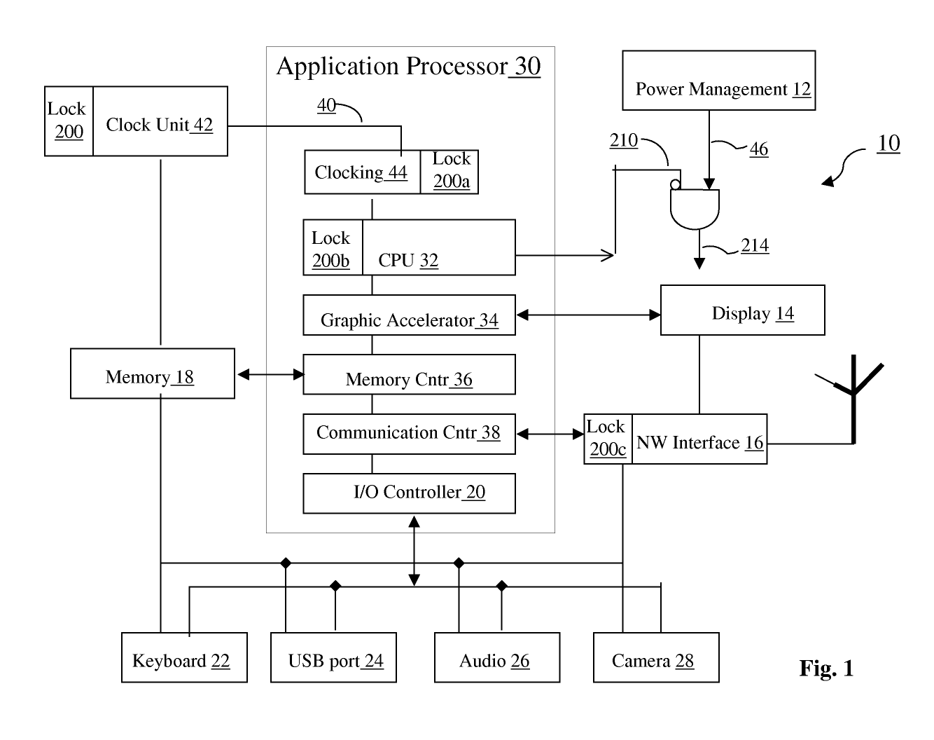

Turning now to FIG. 1, a block diagram of an embodiment of a Mobile Device 10 is shown. A simple embodiment is shown with several functional units to assist in the description of the present invention. The invention applies equally well to all embodiments of Mobile Devices. It should be noted that while a portable device is shown as an example in the description of the invention, embodiments of the present invention may be utilized in any synchronous digital designs such as processors, computer systems, multi-processor systems, memory devices, networking devices, and cell phones.

As shown in FIG. 1, Mobile Device 10 may include several functional units such as an Application Processor 30, a Power Management Unit 12, a Display 14, a Network Interface 16, a Memory 18, a Keyboard/Touchscreen 22, a USB port 24, a Audio device 26, a Camera 28, and a Clock Unit 42. Clock Unit 42 connects all units in Mobile Device 10 via a clock 40. It should be noted that Clock 40 could be same frequency clock going to all devices or different frequency clocks and/or different phase clocks. Application Processor 30 may include functional units such as a CPU 32, a Graphic Accelerator 34, a Memory Controller 36, a Communication Controller 38, an I/O Controller 20 and a Clocking Unit 44.

Application Processors 30 performs most of Mobile Device 10 operations. CPU 32 is the core of Mobile Device 10. Graphic Accelerator 34 is used in high-performance Mobile Device to provide high quality graphic display. Memory Controller 36 controls the operation of Memory 18. Memory 18 may include of hard drive, SDRAM, DDR, DRAM, Flash RAM, and other forms of memory devices. Communication Controller 38 enables Mobile Device 10 to interface with external world via Network Interface 16. Network Interface 16 enables Mobile Device 10 to communicate via various network media are like Bluetooth, GPS, GSM modem, Wi-Fi, and others. Network Interface 16 can also be a wired interface like Ethernet.

I/O Controller 20 of the Application Processor 30 enables Mobile Device 10 to connect to various I/O Devices. I/O Device Keyboard/Touchscreen Device 22 allows users to either type or touchscreen the data. I/O Device USB port 24 allows various USB devices to be connected to Mobile Device 10. I/O Device Audio device 26 provides audio interface to Mobile Device 10 such as microphones, speakers etc. I/O Device Camera 28 captures pictures for Mobile Device 10.

Clock Unit 42 controls the operation of all units within Mobile Device 10 by Clock 40. In one embodiment Clock 40 can be a derivative clock running at various frequencies. In another embodiment Clock 40 can be a group of clocks each running at different frequencies. In one embodiment, Clock 40 going to Memory 18 can be a low-frequency clock when compared to Clock 40 going to application processor 30. Each Clock 40 going to different units can be synchronized with each other or can be unsynchronized.

Power Management 12 provides power to all units. Power Management 12 also controls the operation of each unit by supplying Clock Enable 46. In one embodiment, Clock Enable 46 could be different signals generated for each unit. When the Power Management 12 wants to turn off a unit, it will control the unit by generating inactive Clock Enable 46 to that unit.

It should be noted that in one embodiment, the clock management might be combined with power management as shown in Power Management 12 of FIG. 1. In another embodiment power management and clock management might be separate units.

In FIG. 1, Mobile Device 10 is shown with a locking clock mechanism in accordance with this invention. Clock Unit 42 has a locking mechanism Lock 200. Application Processor 30 has a locking mechanism Lock 200a within Clocking 44. In one embodiment, the locking mechanism can be distributed in various blocks shown as Lock 200b within the CPU 32 and 200c within Network Interface 16.

In one embodiment, locking mechanism is implemented globally across the Mobile Device using Lock 200. In another embodiment, the locking mechanism is implemented as global within the Application Processor 30 using Lock 200a. In other embodiments, it can be implemented local to one or more units using 200b, 200c and so on. FIG. 1 shows embodiments of these global and local locking clock mechanisms.

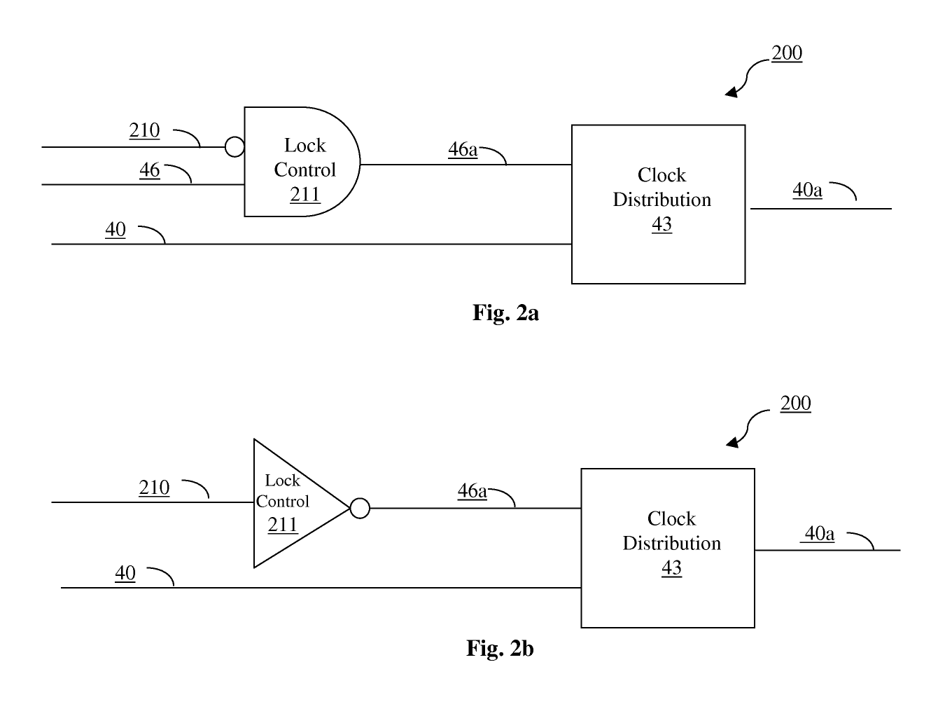

A global lock of the Mobile Device 10 clock can be realized when Lock 200 located in Clock Unit 42 is activated. Application Processor 30 can be locked by Lock 200a located in Clocking 44. Optionally, in one embodiment CPU 32 can be locked by Lock 200b. Local lock can also be achieved by Lock 200c located in Network Interface 16. It should be noted that the lock could be achieved at any unit either globally or locally. While local locking of Application Processor 30 with Lock 200a, locking of CPU with Lock 200b, and locking of Network Interface 16 with Lock 200c are shown in FIG. 2a, it should be noted that locking can be achieved in any one or more of the units in the Mobile Device.

The locking mechanism can be triggered by various events. In one embodiment, as shown in FIG. 1, CPU 32 triggers Lock Clock 210 signal. In this embodiment CPU 32 is programmed to detect conditions of potential security breach. It should be noted that any unit within the Mobile Device 10 could detect the security breach. In one embodiment, Graphic Accelerator 34 could detect the security breach. In another embodiment Network Interface 16 could detect the security breach. In yet another embodiment the I/O devices could detect the security breach. In accordance with the embodiment, security breach could be detected at any location on the device.

In FIG. 1, Lock Clock signal 210 is combined with Clock Enable 46 to control the clocking of Mobile Device 10. No Lock Clock En 214 is generated by combing Clock Enable 46 and security breach signal Lock Clock 210. When Lock Clock 210 is not active, Power Management 12 controls the clock to all units. When Lock Clock 210 is active, lock units 200 will lock respective units it is associated with. It should be noted that in different embodiments different units could be locked. In one embodiment, CPU 32 could be locked. In another embodiment Network Interface 16 could be locked. In another embodiment Application Processor 30 could be locked. In yet another embodiment, Clock Unit 42 could be locked enabling global lock.

Turning now to FIG. 2a, an embodiment of Lock Clock 200 for a Mobile Device 10 with Power Management 12 controlling the clock is shown. Lock Clock 200 has a Lock Control 211 and a Clock Distribution 43. Lock Clock 210 is combined with Clock Enable 46 in Lock Control 211. When there is no lock condition, Clock Enable 46a is generated. Clock Enable 46a will enable Clocks 40 to be activated in Clock Distribution Unit 43 resulting in active Clocks 40a. When Lock Clock 210 is active, Clocks 40a are stopped.

FIG. 2b depicts an embodiment of Lock Clock 200 for a Mobile Device 10 when Power Management 12 does not control clocking mechanism. Lock Clock 200 has a Lock Control 211 and a Clock Distribution 43. Lock Clock 210 controls the enabling of Clock Distribution 43. When lock condition is inactive, Clock Enable 46a is generated. Clock Enable 46a will enable Clocks 40 to be activated in Clock Distribution Unit 43 resulting in active Clocks 40a. When Lock Clock 210 is active, Clocks 40a are stopped.

Next, the mechanism of generating Lock Clock 210 will be considered. In the description below, clock lock mechanism will be described being generated in CPU 32. It should be noted that in other embodiments, clock lock mechanism could be generated in other units.

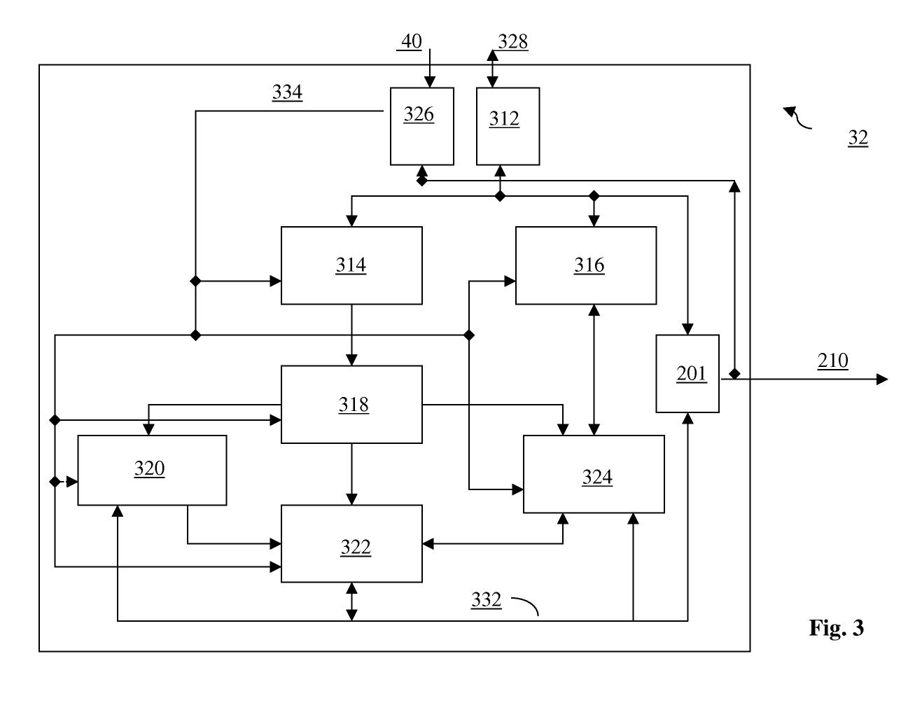

Turning now to FIG. 3, an embodiment of CPU 32 with clock locking mechanism is shown. While the figure shows a simple CPU, the invention can apply equally to any CPU, multi-core processors, vector processor, DSP, Application Processor, or other such processors. In FIG. 3, CPU 32 comprises of multiple digital functional units such as a PLL 326, Bus Interface Unit (BIU) 312, an Instruction Cache 314, a Data Cache 316, a Decode Unit 318, a Register File 320, an Execution Unit 322, and a Memory Data Access Control Unit (MDACU) 324. The CPU 32 interfaces with the external chips through a Bus 328.

The External Clock 40 governs the functioning of CPU 32 in the time domain. An internal Phase Locked Loop (PLL) 326 generates an internal Clock 334 for CPU 32 in synchronization with External Clock 40.

Instruction Cache 314 And Data Cache 316 are coupled to receive instructions and data respectively from Memory 18 through the BIU 312. Decode unit 318 is coupled to receive instruction data from Instruction Cache 314. Decode unit 318 is further coupled with Register File 320, Execution Unit 322 and MDACU 324 to provide instruction control information to these units. Further, Register File 320 is coupled with Execution Unit 322 in providing data for execution. Similarly, MDACU 324 is coupled with Execution Unit 322 in providing access to memory data. Also, the MDACU 324 is coupled with Data Cache 316.

Generally speaking, instructions are fetched from main memory and stored into Instruction Cache 314 through BIU 312. During execution, instructions are fetched from the Instruction Cache 314 and decoded by Decode Unit 318 that drives the Execution Unit 322 to execute the decoded instruction/instructions. Execution Unit 322 gets the operand data for execution from either Register File 320 and/or Data Cache 316 through MDACU 324. Results generated from Execution Unit 322 are written back to Register File 320 and/or Data Cache 316 through MDACU 324.

Traditionally, each of these units described above constitutes one or more pipeline stages in a microprocessor. If an instruction (e.g., I1) is fetched from Instruction Cache 314 during a clock (say C1), during the next clock cycle (say C2), instruction I1 will be in the decode unit 14 while the next instruction (say I2) is being fetched from the Instruction Cache 314. Thus pipelining enables simultaneous operation of multiple instructions. In general, number of pipeline stages increases with the design complexity and the clock frequency. The term clock frequency refers to number of clock cycles within a time unit, usually a second.

Further, in typical synchronous designs, a central Clock 334 (shown in dashed lines) derived from External Clock 40 through PLL 326 is distributed to all digital functional units (or blocks) of CPU 32. Data passes from one block to the other using one of the two clock edges provided by central internal Clock 334.

Lock 201 is shown generating Lock Clock 210 signal. Lock Clock 210 connects to PLL 326 to control the local Clock 334. When Lock Clock 210 is enabled, PLL 326 can be designed to lock the operation of the CPU 32 with Clock 334. In the figure Lock 201 is shown as a block with dashed lines. In an implementation, this could be a software program, hardware logic, micro-code segment, or a combination of these.

In one embodiment Lock Clock 210 can be used only to lock CPU 32. In another embodiment Lock Clock 210 can be connected to other units in Mobile Device 10.

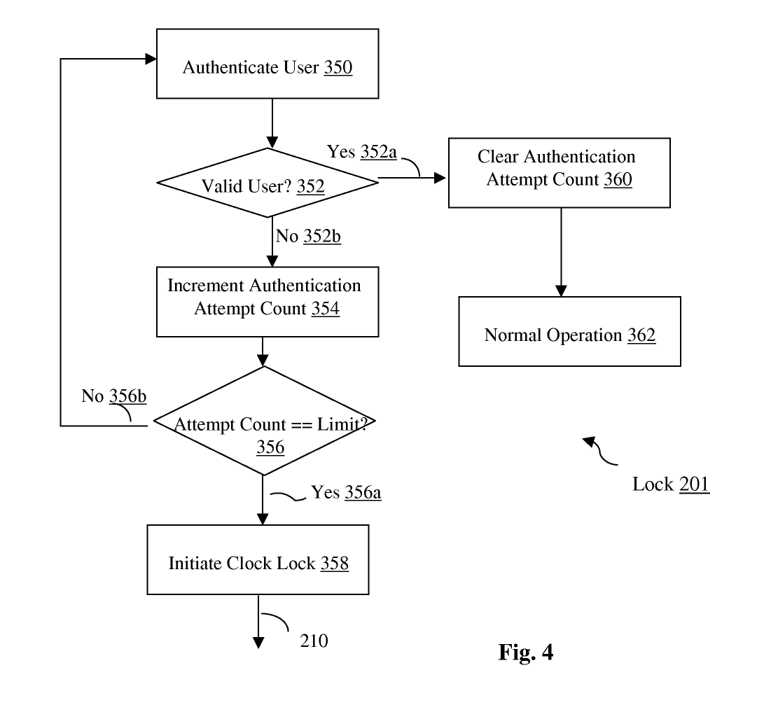

Turning now to FIG. 4, an embodiment of Lock 201 for generating Lock Clock 210 is shown. In one embodiment this can be a hardware block. In another embodiment, this can be a software code segment. In yet another embodiment, Lock 201 can be a micro-code segment. In yet another embodiment, Lock 201 is implemented as a combination of hardware, software, and/or micro-code.

As a sample embodiment, Lock 201 has an Authenticate User block 350 that is coupled to a User Valid Checking Block 352. This is coupled to Clear Authentication Attempt Count block 360 and Increment Authentication Attempt Count block 354. Clear Authentication Attempt Count block 360 is coupled to Normal Operations block 362. Increment Authentication Attempt Count block 354 is coupled to Attempt Count Limit checking block 356. This Attempt Count Limit checking block 356 is coupled to Authenticate User block 350 and Initiate Clock Lock block 358. Initiate Clock Block 356 generates Lock Clock 210.

The simple mechanism shown here depicts Authenticate User 350 authenticating the user. Authenticate User 350 will be invoked during the power-up and/or login. In one embodiment, this authentication is invoked at regular intervals to assure the security of the Mobile Device. In another embodiment, authentication is triggered when certain preset conditions are detected.

Valid User 352 checks if the user is authorized to use the Mobile Device 10. This authentication process may comprise of various embodiments such as the simple password checking mechanism, hardware port checking mechanism, biometric checking mechanism, or other authentication mechanism embodiments. Biometrics verification includes fingerprint, DNA, face recognition, eye scan etc. If authentication checking passes shown by 352a in FIG. 4, Clear Authentication Attempt Count 360 will clear the authentication attempt count and send the operational flow to Normal Operations 363. If the authentication fails as shown by 352b, Increment Authentication Attempt Count 354 will increment the attempts count and send the operation flow to checking the attempt count in Attempt Count Limit checking block 356. If the authentication attempt has not exceeded the preset limit, the flow will be sent to retrying the authentication process in Authenticate User 350 as shown by 356b. Authentication process will be repeated until the limit is reached. When the preset attempt count is exceed as shown by 356a, Lock Clock 210 will be asserted by Initiate Clock Lock 358.

In one embodiment the authentication limit could be set to one. In this case Mobile Device 10 will lockup when the authentication fails the very first time. This may be required in an extremely security conscious application. In one embodiment, the authentication limit may be made programmable to be set based on the security requirements of each deployment.

In one embodiment, as shown in FIG. 3, Lock Clock 210 can lock the CPU 32. Such a lock may require a hardware reset to bring the Mobile Device 10 to operational mode again.

In another embodiment Lock Clock 210 can be used to lock other units in Mobile Device 10. In this case Lock Clock 210 can be generated as in interrupt. The interrupt signal could be connected to clocks of other units in Mobile Device 10.

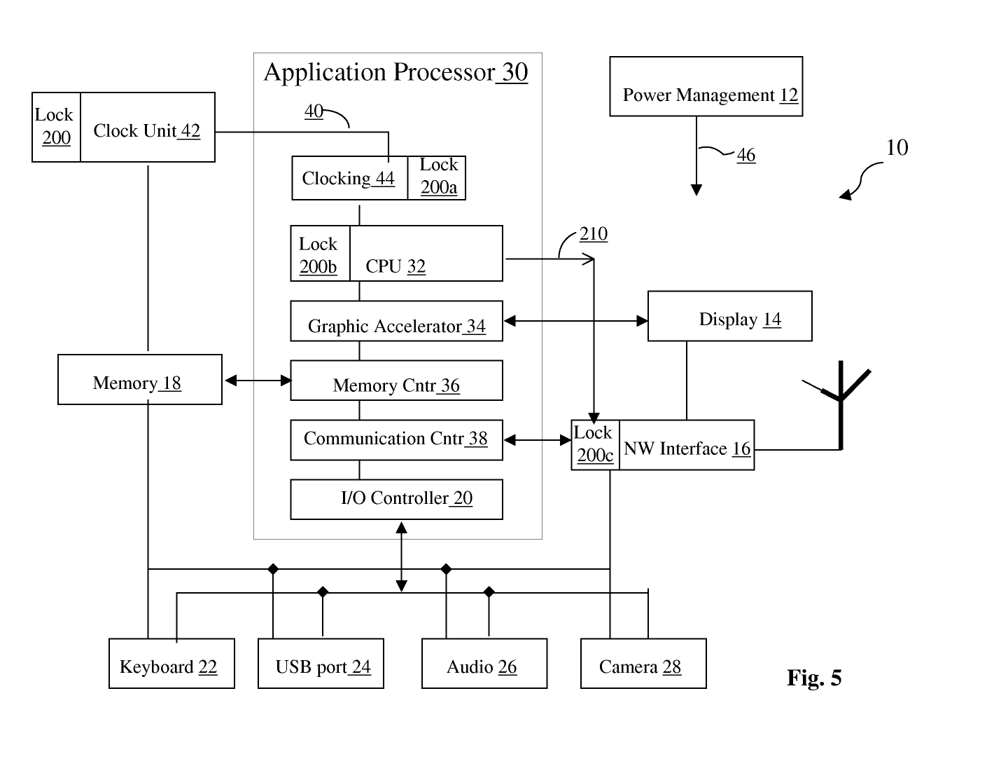

Turning now to FIG. 5, an embodiment of Mobile Device 10 with CPU 32 generating Lock Clock 210 as an interrupt is shown. In this embodiment, the interrupt feeds into Network Interface 16.

In one embodiment, the interrupt may connect to other units of the Mobile Device 10 such as Memory 18, Display 14, etc.

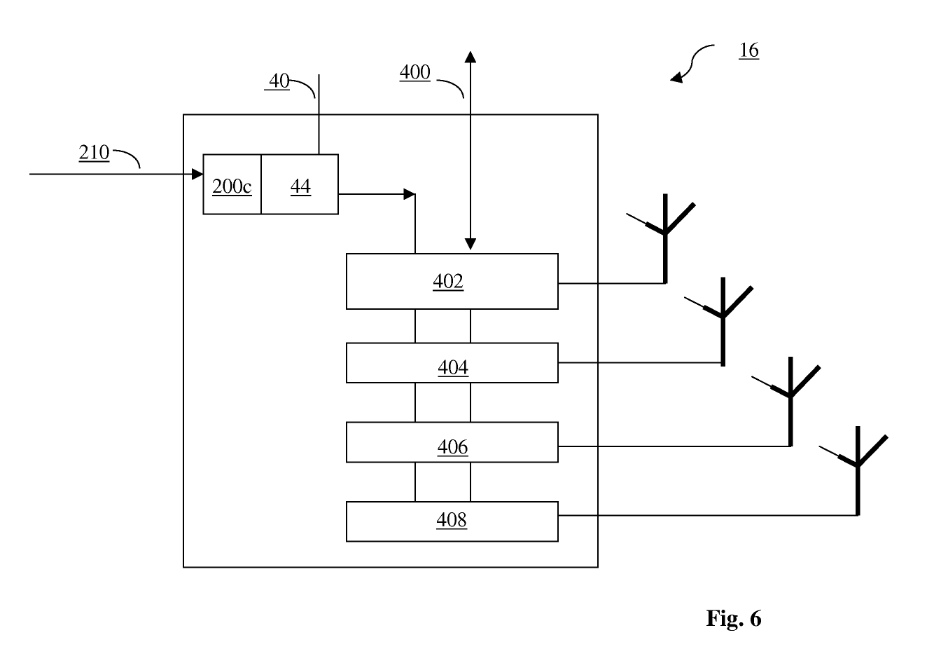

Turning now to FIG. 6, an embodiment of Network Interface 16 with one or more of WiFi ports 402, one or more of Bluetooth Module 404, one or more of GPS Module 406, one or more of GPRS/GSM Modem 408, and a Clocking unit 44 with lock 200c is shown. Lock Clock 210 feeds into Network Interface 16 and drives Lock 200c unit. When CPU 32 generates Lock Clock 210 interrupt, Lock 200c within Clocking 44 of Network Interface 16 blocks all communication ports effectively rendering Mobile Device 10 blocked from communicating with the external world.

In the process of securing breached Mobile Devices, there could be occasional inadvertent blocking of the device. In such situations, it is optimal to reactivate the Mobile Device after the security risk has been resolved. Reactivation of the Mobile Device can be done remotely, locally, or at the Enterprise site.

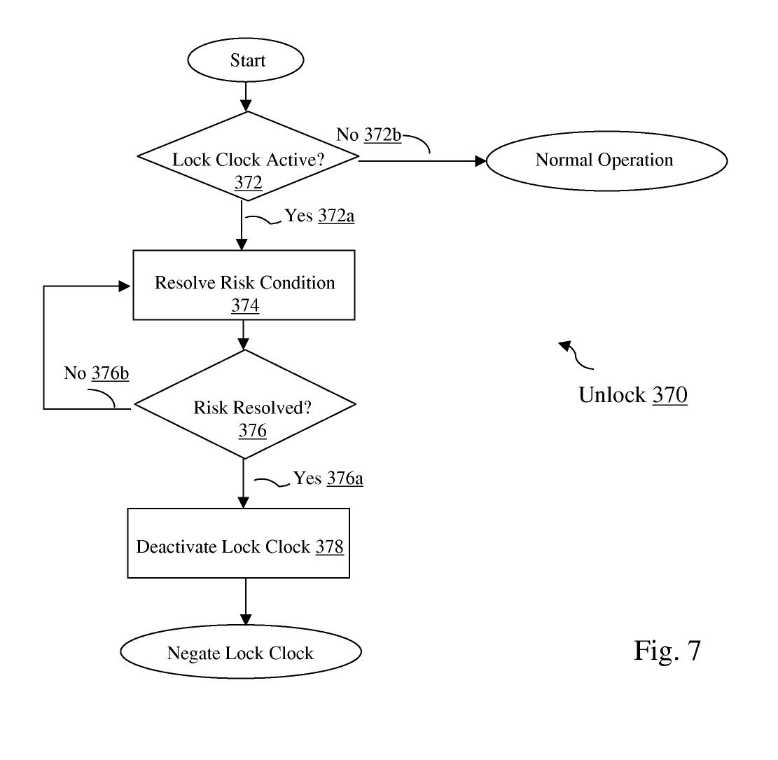

Turning to FIG. 7, a method Unlock 370, for deactivating the Lock Clock if and after the security risk is resolved is shown. In Unlock 370, locking mechanism is resolved by CPU 32 by deactivating the Lock Clock 210. Unlock 370 can be implemented in hardware, software, or micro-code. The method comprises of a Lock Clock Active 372, a Resolve Risk Condition 374, a Risk Resolved block 376, and a Deactivate Lock Clock 378. Lock Clock Active 372 tests if a lock condition is asserted. If it is not asserted, Mobile Device 10 will continue to perform normal operations as shown by 372b. When Lock Clock Active 372 detects a Lock Clock condition, the operation flows to Resolve Risk Condition 374 as shown by 372a. Risk Resolved 376 waits for the security breach to be resolved as shown by 376b. If and when the condition is resolved, the flow moves to Deactivate Lock Clock 378 as shown by 376a. This will deactivate the Lock Clock 210 signal. When Lock Clock 210 is deactivated by the CPU, it will re-enable the blocked modules like Network Interface 16 shown in FIG. 6.

While Unlock 370 of FIG. 7 shows one mechanism to resolve the lock clock situation in a CPU, Mobile Device 10 may be reactivated in several ways. In one embodiment, Mobile Device 10 can be reactivated remotely by invoking a preset program within the CPU. In another embodiment, Mobile Device 10 can be reactivated by running a preset program via a command through the keyboard. In yet another embodiment, Mobile Device 10 can be reactivated following a hardware reset.

As can be seen, there are various ways of locking and unlocking Mobile Device 10 by using clock locking mechanism. The embodiments described in the figures are illustrative for demonstrating the workings of the mechanism. It is not limiting the possible implementation of various embodiments.

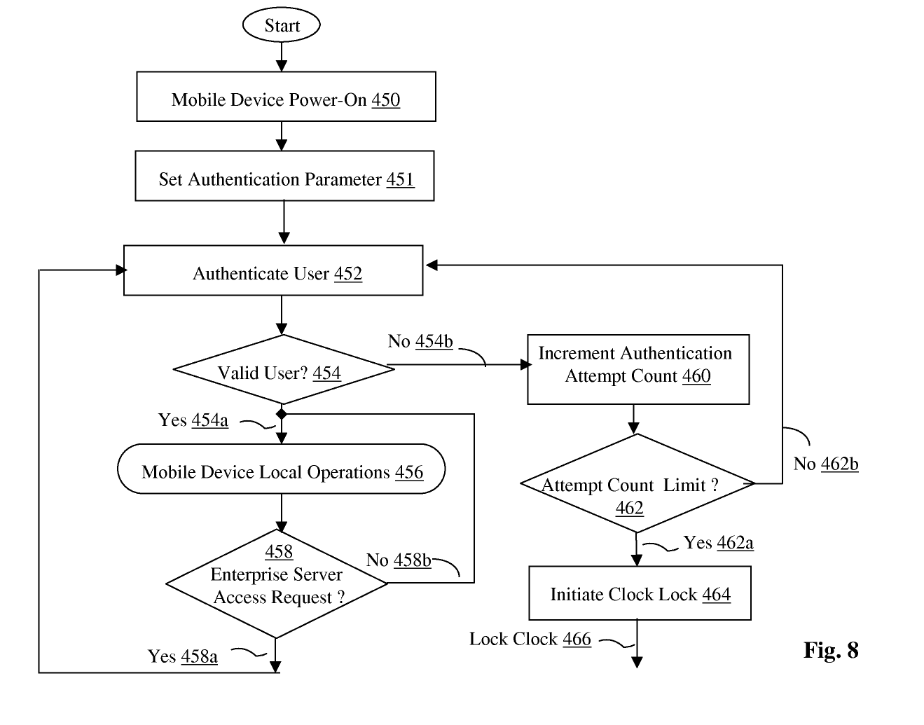

Turning now to FIG. 8, a method for protecting the Enterprise Server and Mobile Device is shown using the clock lock mechanism of this invention. The method demonstrates the operation of Mobile Device 10 starting from power-on shown as Mobile Device Power-On state 450. Following the power-on, the device is initialized by Set Authentication Parameter 451. Following this, Authenticate User state 452 is entered. Following the process of authenticating user with mechanisms like password, hardware key, and other mechanisms, the validity of the user trying to authenticate is verified in Valid User 454 query.

If the authentication passes in Valid User 454 verification, Mobile Device 10 operations are enabled as shown by 454a.

If the verification fails, as shown by 454b, the authentication attempted is incremented in Increment Authentication Attempt Count 460. The attempt count is verified in Attempt Count Limit 462 module. If the limit has not reached, the flow goes to Authenticate User 452 and the authentication process is restarted. If the authentication count limit is reached, flow goes to Initiate Clock Lock 464 that activates Lock Clock 466.

In one embodiment, Mobile Device 10 will have additional authentication for accessing the Enterprise Server. This is depicted by Enterprise Server Access Request 458 module in FIG. 9. Following a successful authentication of Mobile Device 10 for local operations, the flow will go to Enterprise Server Access Request 458 module in this embodiment. If there is an access request to the Enterprise Server, the module 458 will take the flow to Authenticate User 452 as shown by 458a. If there is no server access request as shown by 458b, the device will continue to operate in local mode. Authenticate User 452 will initiate another authentication process for Enterprise Server access.

In one embodiment, Authentication Attempt Count is set by Set Authentication Parameter 451 to allow tolerance for potential unsuccessful authentication attempts. In one embodiment with high security demand, Authentication Attempt Count may be set to trigger lock clock when the authentication fails for the first time.

In another embodiment, the Authentication Attempt Count could be set to ‘n’ which is greater than 1 to provide some lenience during authentication.

When a Mobile Device requires additional authentication process for accessing the Enterprise Server, in one embodiment, the process is same as the one used to authenticate the Mobile Device operation. In another embodiment, the authentication process for accessing the Enterprise Server is different from the authentication process for enabling Mobile Device operations.

In one embodiment, the Mobile Device is in normal mode of operation and if the device needs to access the Enterprise Server, the authentication process will initiate itself everytime. This will ensure that the Enterprise Server is safe even when the Mobile Device is compromised after the device is turned on and authenticated.

In accordance with above disclosure, a digital design has been shown to comprise of a mechanism to protect the integrity of Enterprise Server and Mobile Device. It contemplates achieving this by locking the remote devices by stopping the clocks to one or more units of the system. The invention contemplates mechanisms to detect a security breach. It further contemplates mechanisms to lock the remote device when security breach is detected.

While the above description contains many specificities, these should not be construed as limitations on the scope of the invention, but rather as an exemplification of preferred embodiments thereof. Accordingly, the scope of the invention should be determined not by the embodiment(s) illustrated, but by the appended claims and their legal equivalents.

1. An apparatus comprising:
a digital circuitry;
a clock unit controlling a clock coupled to a portion of the digital circuitry;
a validation unit to verify validity of an operator; and
a lock unit to disable the portion of the digital circuitry upon a invalid operator event.

2. The apparatus of claim 1, further comprising of an enable logic to re-enable the portion of the digital circuitry.

3. The apparatus of claim 1, wherein the digital circuitry further comprises of a power management unit to disable clocks to a portion of the digital circuitry and the lock unit is coupled to the power management unit.

4. The apparatus of claim 1, wherein the digital circuitry comprises of one or more portions with at least one portion comprises the lock unit.

5. The apparatus of claim 4, wherein the lock unit of a portion of the digital circuitry controls the lock unit of another portion of the digital circuitry.

6. The apparatus of claim 1, wherein the validation unit verifies the validity of the operator using a pre-assigned data comparison mechanism.

7. The apparatus of claim 1, wherein the validation unit verifies the validity of the operator using biometrics.

8. The apparatus of claim 6, wherein the validation unit further verifies the authenticity of the operator using biometrics.

9. The apparatus of claim 1, wherein the validation unit verifies the validity of the operator periodically.

10. A method comprising:
verifying validity of an operator; and
if not valid, disabling a portion of a mobile device by stopping clock to a portion of the mobile device.

11. The method of claim 10, wherein verifying the validity of the operator comprises a plurality of validation attempts based on a preset validation attempt count.

12. The method of claim 10, wherein verifying the validity of the operator of the mobile device comprises a comparison to a pre-assigned data.

13. The method of claim 10, wherein verifying the validity of the operator of the mobile device comprises a comparison to a biometric data.

14. The method of claim 10, wherein verifying the validity of the operator of the mobile device occurs periodically.

15. The method of claim 10, further verifying the block condition after the mobile device is blocked.

16. The method of claim 15, further including the unblocking of the mobile device following a false block event.

17. The method of claim 10, further verifying the operator for accessing an enterprise server.

18. The method of claim 17, wherein decoupling of the enterprise server from the mobile device occurs upon a invalid access attempt by the mobile device.

19. An enterprise information technology system, comprising:
a mobile device comprising, a clock unit, a validation unit, and a lock unit, wherein the lock unit disables clocks to one or more portion of the mobile device upon an invalid operator event; and
a server computer that couples to the mobile device.

20. The enterprise information technology system of claim 19, wherein the server computer decouples from the mobile device upon an invalid operator event.
